(19) United States
(12) Patent Application Publication
(10) Pub. No.: US 2025/0313475 A1
(43) Pub. Date: Oct. 9, 2025

(54) GRAPHENE MANUFACTURING METHOD

(71) Applicant: Jonquil Consulting Inc., Tokyo (JP)

(72) Inventor: Shigeru OCHIAI, Tokyo (JP)

(73) Assignee: Jonquil Consulting Inc., Tokyo (JP)

(21) Appl. No.: 18/629,110

(22) Filed: Apr. 8, 2024

(51) Int. Cl. C01B 32/186

(52) U.S. Cl. CPC C01B 32/186; C01P 2002/85

(57) ABSTRACT

There is provided a graphene manufacturing method. The method comprises recovering a gas containing carbon dioxide by removing water from a mixture containing the water and the carbon dioxide, and generating graphene by heating the recovered gas containing the carbon dioxide in a quartz vessel at a temperature of not more than 1,700° C.

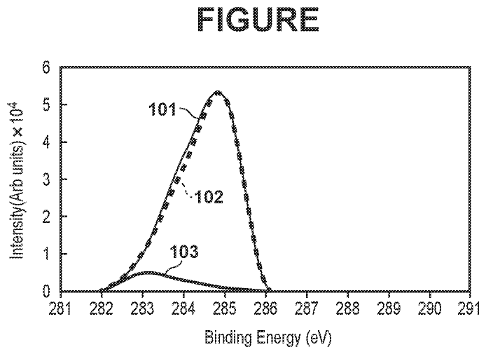

### BACKGROUND OF THE INVENTION

### Field of the Invention

The present invention relates to a graphene manufacturing method.

### Description of the Related Art

There are three conventional graphene manufacturing methods. The first method is a CVD method for chemically synthesizing graphene from a raw material gas in a vapor phase (Japanese Patent No. 5686418). The CVD method is a method of converting a carbon precursor into graphene on a catalyst surface. The second method is a scotch tape method of mechanically peeling graphene from a graphite crystal (Novoselov, K. S. et al., “Electric field effect in atomically thin carbon films”, Science 306 (2004) pp. 666-669). The scotch tape method is a method of sticking a tape to a layered material and peeling it off, and repeating the same operation for a part remaining on the tape, thereby producing a material with a single layer (or a smaller number of layers). The third method is a Hummers method for peeling graphene by an oxidation process in a liquid phase (Japanese Patent Laid-Open No. 2024-022310). The Hummers method is a method of synthesizing graphene by oxidizing graphite, and graphite oxide is prepared from natural flake graphite, and reduced graphene oxide can be obtained by chemical reduction of the graphene oxide.

However, the conventional graphene manufacturing methods are not suitable for industrial use in a wide range because it is difficult to mass-produce graphene at a low cost. For example, in the CVD method, since a metal catalyst and a transfer process are necessary, mass production is difficult, and the manufacturing cost is high. The scotch tape method is not suitable for commercial production of graphene because a repetitive work of sticking a single-layered film to a base occurs. In the Hummers method, since a process of reducing graphene oxide is necessary, mass production is difficult, and the manufacturing cost is high.

### SUMMARY OF THE INVENTION

It is an object of the present invention to mass-produce graphene at a low cost.

Some embodiments of the present disclosure provide a graphene manufacturing method comprising recovering a gas containing carbon dioxide by removing water from a mixture containing the water and the carbon dioxide, and generating graphene by heating the recovered gas containing the carbon dioxide in a quartz vessel at a temperature of not more than 1,700° C.

Further features of the present invention will become apparent from the following description of exemplary embodiments (with reference to the attached drawings).

### BRIEF DESCRIPTION OF THE DRAWINGS

Figure is a view showing XPS analysis results of graphene of Examples 1 and 2 and a comparative example (commercially available graphite).

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### <Graphene Manufacturing Method>

A graphene manufacturing method according to an embodiment includes recovering a gas containing carbon dioxide by removing water from a mixture containing the water and the carbon dioxide, and generating graphene by heating the recovered gas containing the carbon dioxide in a quartz vessel at a temperature of not more than 1,700° C. Graphene has conductivity, optical characteristics, spin transport properties, a magnetic field effect, and the like and can be used as, for example, an electronic device constituent element.

### <Mixture>

The mixture contains water and carbon dioxide. As the mixture, for example, natural gas or a gas (to be also referred to as an exhaust gas hereinafter) discharged from a thermal power plant, a boiler of a manufactory, a kiln of a cement factory, a blast furnace and a converter of steel works, an incinerator, or the like can be used. In a graphene manufacturing method according to an embodiment, water may directly be removed from these mixtures, and after that, a carbon dioxide containing gas may be heated in a quartz vessel, thereby generating graphene. In a graphene manufacturing method according to another embodiment, these mixtures may temporarily be brought into contact with calcium hydroxide, carbon dioxide may be recovered as calcium carbonate and separated from active ingredients in natural gas or other component gases in an exhaust gas from a power plant or the like, and after that, a substance obtained by firing the recovered calcium carbonate may be used as the mixture. Note that as for the graphene manufacturing method according to the present invention, for the descriptive convenience, the graphene manufacturing method according another embodiment will be described as an example.

### (Carbon Dioxide)

Carbon dioxide contacts the aqueous dispersion of calcium hydroxide to be described later and is recovered as calcium carbonate to be described later.

Thus, carbon dioxide is processed (consumed) by contacting the aqueous dispersion of calcium hydroxide. Here, the concentration of carbon dioxide according to the embodiment is 5 vol % or more, 10 vol % or more, or 20 vol % or more in natural gas or the exhaust gas. Also, the concentration of carbon dioxide is 50 vol % or less, 40 vol % or less, or 30 vol % or less. The range of the concentration of carbon dioxide can be a combination of arbitrary lower and upper limit values described above.

### <Aqueous Dispersion of Calcium Hydroxide>

The aqueous dispersion contains water and calcium hydroxide (slaked lime, Ca(OH)₂). The aqueous dispersion may further contain acetonitrile (CH₃CN) to adjust the absorption speed of carbon dioxide.

The concentration of calcium hydroxide to the aqueous dispersion containing water and calcium hydroxide is not particularly limited. The concentration of calcium hydroxide as a solid content is 1 wt % or more, 5 wt % or more, 10 wt % or more, 20 wt % or more, or 30 wt % or more. This improves the absorption efficiency of carbon dioxide in the aqueous dispersion. Also, the concentration of calcium hydroxide as a solid content is 80 wt % or less, 70 wt % or less, 60 wt % or less, 50 wt % or less, or 40 wt % or less. Thus, the aqueous dispersion obtains an appropriate viscosity, and reaction to calcium hydroxide and carbon dioxide is even. The range of the concentration of calcium hydroxide can be a combination of arbitrary lower and upper limit values described above. Note that if the aqueous dispersion contains acetonitrile, the concentration of calcium hydroxide can be a concentration to the aqueous dispersion containing water, calcium hydroxide, and acetonitrile.

The concentration of acetonitrile to the aqueous dispersion containing water, calcium hydroxide, and acetonitrile is 1 wt % or more, 5 wt % or more, 10 wt % or more, or 20 wt % or more. Also, the concentration of acetonitrile is 60 wt % or less, 50 wt % or less, 40 wt % or less, or 30 wt % or less. This can facilitate adjustment of the absorption speed of carbon dioxide in the aqueous dispersion. The range of the concentration of acetonitrile can be a combination of arbitrary lower and upper limit values described above.

In the embodiment, the aqueous dispersion is formed by preparing a dispersion of water and calcium hydroxide in advance and putting acetonitrile into the dispersion. The dispersion of water and calcium hydroxide can be formed by adding calcium hydroxide or calcium oxide to water. Alternatively, as the dispersion of water and calcium hydroxide, a dispersion of commercially available water and calcium hydroxide can be used.

In the embodiment, calcium hydroxide can be obtained by making a calcium salt and a hydroxide of an alkali metal to react with each other.

Examples of a calcium salt are calcium chloride and calcium sulfate. Examples of a hydroxide of an alkali metal are sodium hydroxide, potassium hydroxide, and lithium hydroxide.

The purity of calcium hydroxide is 80 wt % or more, 90 wt % or more, or 95 wt % or more. This improves the absorption efficiency of carbon dioxide in the aqueous dispersion.

In the embodiment, calcium hydroxide can be powder. The average particle size (D50) of calcium hydroxide is 1,000 μm or less, 500 μm or less, 100 μm or less, 50 μm or less, or 1 μm or less. Also, the average particle size (D50) of calcium hydroxide is 0.01 μm or more, 0.1 μm or more, 0.5 μm or more, 0.7 μm or more, or 0.9 μm or more. The average particle size (D50) of calcium hydroxide can be a combination of arbitrary lower and upper limit values described above. If calcium hydroxide has such an average particle size, reaction between calcium hydroxide and carbon dioxide improves. The average particle size (D50) is a value obtained by a particle size distribution on a volume basis based on the laser diffraction/scattering method, and the D50 value means a particle size (median diameter) at a cumulative of 50%.

Water need only function as a solvent, and examples are tap water, underground water, distilled water, and ion exchange water.

### (Acetonitrile)

The purity of acetonitrile is 90 wt % or more, 95 wt % or more, 98 wt % or more, or 99 wt % or more. This improves adjustment of the absorption speed of carbon dioxide in the aqueous dispersion.

### (Additive)

The aqueous dispersion can contain, for example, a dispersant as various additives. Examples of the dispersant are a dispersant of an inorganic compound and a high molecular surfactant. Hence, even if the solid concentration of calcium hydroxide is high, the dispersibility of calcium hydroxide improves, and reaction between calcium hydroxide and carbon dioxide becomes even. In the embodiment, as for the dispersant, when preparing a dispersion of water and calcium hydroxide, the dispersant is put into water in advance, and calcium hydroxide or calcium oxide is then put into the water, thereby evenly dispersing calcium hydroxide.

### <Calcium Carbonate>

When contact and reaction between the carbon dioxide and the aqueous dispersion are performed, calcium carbonate is generated. Calcium carbonate can be recovered by a conventionally known method such as filtering. As described above, the mixture used in the graphene manufacturing method according to another embodiment is obtained by firing a precipitate of calcium carbonate obtained by making carbon dioxide react with calcium hydroxide.

### (Firing Temperature)

The temperature to fire the precipitate of calcium carbonate according to the embodiment is 600° C. or more, 700° C. or more, 800° C. or more, 850° C. or more, 900° C. or more, or 950° C. or more. The temperature to fire the precipitate of calcium carbonate is about 2,600° C. (the melting point of calcium oxide) or less, and is 1,500° C. or less, 1,200° C. or less, or 1,000° C. or less. The temperature to fire the precipitate of calcium carbonate can be a combination of arbitrary lower and upper limit values described above. The temperature to fire the precipitate of calcium carbonate according to the embodiment is 600° C. to 1,500° C. If firing is performed in the above-described temperature range, calcium carbonate can sufficiently be decomposed into calcium oxide and carbon dioxide.

### (Firing Time)

The time to fire the precipitate of calcium carbonate is 1 min, 5 min, 10 min, 1 hr or more, 1.5 hrs or more, or 2 hrs or more. The firing time to fire the precipitate of calcium carbonate is 7 hrs or less, 6 hrs or less, 5 hrs or less, 4 hrs or less, or 3 hrs or less. The time to fire the precipitate of calcium carbonate can be a combination of arbitrary lower and upper limit values described above. The time to fire the precipitate of calcium carbonate according to the embodiment is 1 min to 7 hrs. If firing is performed in the above-described firing time range, calcium carbonate can sufficiently be decomposed into calcium oxide and carbon dioxide.

### <Step of Recovering Gas Containing Carbon Dioxide>

The recovery step according to the embodiment includes recovering a gas containing carbon dioxide by removing water from a mixture containing the water and the carbon dioxide. Note that the recovered gas containing carbon dioxide is the raw material of graphene.

In the recovery step, for example, a method of cooling the mixture and a method using an absorbent can be used. In the recovery step, one of above-described methods may be used solely, or the combination of the above-described methods may be used.

### (Method of Cooling Mixture)

The recovery step according to the embodiment includes removing water by cooling the mixture. The temperature (at 1 atm) to cool the mixture is −78° C. or more, −70° C. or more, −60° C. or more, −50° C. or more, −40° C. or more, or −30° C. or more. The temperature (at 1 atm) to cool the mixture is 100° C. or less, 90° C. or less, 80° C. or less, 70° C. or less, 60° C. or less, 50° C. or less, 40° C. or less, 30° C. or less, 20° C. or less, 10° C. or less, 0° C. or less, −10° C. or less, or −20° C. or less. The range of the temperature to cool the mixture can be a combination of arbitrary lower and upper limit values described above.

The temperature (at 1 atm) to cool the mixture according to the embodiment is −78° C. to 100° C. If the temperature exceeds 0° C., the gas containing carbon dioxide can be recovered by removing water that is a liquid from the mixture. If the temperature is 0° C. or less, the gas containing carbon dioxide can be recovered by freezing water in the mixture. Note that if the temperature to cool the mixture is −79° C. or less, carbon dioxide in the mixture is frozen, and therefore, the gas containing carbon dioxide cannot be recovered from the mixture. On the other hand, if the temperature to cool the mixture exceeds 100° C., water in the mixture changes to steam, and therefore, water cannot be removed from the mixture.

The temperature (at 1 atm) to cool the mixture according to another embodiment is −78° C. to 0° C. In this temperature range, the gas containing carbon dioxide can be recovered by freezing water in the mixture. Note that a description concerning a case where the temperature to cool the mixture is −79° C. or less is the same as the above description, and a description thereof will be omitted.

As a means for cooling the mixture, for example, one or more heat exchangers can be used. The heat exchanger includes, for example, a metal tube covered with a coolant. Examples of the metal tube are a stainless steel tube and an aluminum tube. Examples of the coolant are dry ice and liquid nitrogen. The mixture is passed through the above-described heat exchanger to cause state change from steam to water or from water to ice, but the state of carbon dioxide is not changed. It is therefore possible to remove water from the mixture and recover the gas containing carbon dioxide.

### (Method Using Absorbent)

The absorbent is a substance that maintains a dry state by absorbing water in air. Examples of the absorbent for removing water from the mixture are silica gel, quick lime, calcium chloride, zeolite, and clay mineral bentonite. The use amount of the absorbent need only be an amount within a range where water can be removed from the mixture. If the mixture is left stand under the existence of the absorbent, the absorbent absorbs water in the mixture but does not absorb carbon dioxide. It is therefore possible to remove water from the mixture and recover the gas containing carbon dioxide. Note that in the method using the absorbent, the temperature of the mixture need not be managed.

### <Step of Generating Graphene>

The generating step includes generating graphene by heating the recovered gas containing the carbon dioxide in a quartz vessel at a temperature of 1,700° C. or less.

### (Vessel)

The vessel to which the recovered gas containing carbon dioxide is introduced is preferably, for example, a cylindrical quartz vessel from the viewpoint of resistance to a high heating temperature, light transmissivity, and chemical resistance. The quartz vessel is a vessel of silica glass made of silicon dioxide (SiO₂), and is a vessel rarely containing metal impurities. Examples of silica glass are fused quartz and synthetic quartz. Fused quartz is generated from quartz powder obtained by fusing/refining a natural crystal. Synthetic quartz is chemically synthesized using ultrahigh purity silicon tetrachloride, and its purity is higher than that of fused quartz. For example, the purity of synthetic quartz is 99.99% or more. Silica glass has properties that the molecular structure is simple and firm, and thermal deformation hardly occurs. For this reason, the softening point of the quartz vessel is, for example, about 1,700° C. The silica glass that is excellent in various kinds of physical characteristics is used in various fields such as optical fiber, optical filter, physical and chemical experiment equipment, optical lens, and inspection window in incinerator. Here, in the conventional CVD method, a metal foil substrate is generally used. For this reason, to generate graphene without changing the surface shape of the metal foil substrate and causing evaporation of the metal foil, plasma processing needs to be performed at a temperature much lower than the melting point of a metal catalyst. For example, in a case of a copper foil substrate that generally uses a metal catalyst to manufacture graphene, processing needs to be performed at a temperature much lower than the melting point (1,080° C.) of copper. On the other hand, since the softening point of the quartz vessel according to the present invention is about 1,700° C., according to the present invention, graphene can be manufactured at a heating temperature higher than the CVD method. As described above, since the present invention has an advantage that graphene can be manufactured within a higher temperature range (for example, 1,000° C. or more) than in the CVD method, for example, mass production of graphene in a commercial plant can be implemented.

The shape of the vessel according to the embodiment is, for example, a cylindrical shape, a linear shape, a curved shape (a U shape, a V shape, or the like), or a combination of these shapes. The vessel according to the embodiment is a sealed reactor that confines introduced carbon dioxide, but is not limited to this. For example, the vessel may be a circulation reactor. The circulation reactor is a device that continuously supplies the raw material (that is, the recovered gas containing carbon dioxide) of graphene from one end of the reactor and continuously extracts graphene from the other end of the reactor. If the vessel is a circulation reactor, a pressure pump, a temperature sensor, a pressure sensor, a cooling water tank, a pressure control valve, and a graphene recovery vessel can arbitrarily be provided. If the vessel is a circulation reactor, since the graphene manufacturing time can be shortened as compared to the sealed reactor, mass production of graphene is possible.

### (Heating Temperature)

The temperature to heat the gas containing carbon dioxide in the quartz vessel according to the embodiment is 1,700° C. or less, 1,600° C. or less, or 1,500° C. or less. The temperature to heat carbon dioxide in the quartz vessel is 1,000° C. or more, 1,100° C. or more, or 1,200° C. or more. The range of the temperature to heat the gas containing carbon dioxide in the quartz vessel can be a combination of arbitrary lower and upper limit values described above. This can efficiently generate graphene.

### (Heating Time)

The time to heat the gas containing carbon dioxide in the quartz vessel according to the embodiment is 5 min or more, 10 min or more, or 15 min or more. The time to heat the gas containing carbon dioxide in the quartz vessel is 3 hrs or less, 2 hrs or less, or 1 hr or less. The time to heat the gas containing carbon dioxide in the quartz vessel can be a combination of arbitrary lower and upper limit values described above. The time to heat the gas containing carbon dioxide in the quartz vessel according to the embodiment is 5 min to 1 hr. This can efficiently generate graphene.

### (Atmosphere)

The atmosphere in the quartz vessel according to the embodiment is an inert gas or a vacuum. Examples of the atmosphere in the quartz vessel at the time of heating are inert gases such as nitrogen, argon, and helium and a vacuum. If graphene is generated in an environment without oxygen, graphene with a few oxygen functional groups can be obtained, and therefore, the reduction process of graphene can be omitted. Note that heating processing under an oxygen containing atmosphere such as air is not preferable because graphene is burnt down.

The pressure in a case where the atmosphere in the quartz vessel is a vacuum is 1 Pa or more, 5 Pa or more, 10 Pa or more, or 20 Pa or more. Also, the pressure is 200 Pa or less, 180 Pa or less, 160 Pa or less, or 140 Pa or less. The range of the pressure can be a combination of arbitrary lower and upper limit values described above. If graphene is generated in an environment with a little oxygen, graphene with a few oxygen functional groups can be obtained, and therefore, the reduction process of graphene can be omitted.

### (Catalyst)

The generating step according to the embodiment includes heating the recovered gas containing the carbon dioxide in the quartz vessel without using a catalyst. Examples of the catalyst are metal catalysts of nickel, copper, and cobalt, and noble metals such as iridium and platinum. Growth of single-layered graphene by the CVD method is done on a copper foil in general. In the CVD method using a metal catalyst, however, since graphene needs to be transferred to an insulating substrate, the cost increases due to the metal catalyst etching step and the transfer step. Also, the prices of metal catalysts easily rise due to geopolitical risks and constraints on reserves. For this reason, market needs for a graphene manufacturing method without using a metal catalyst, which leads to cost reduction of graphene manufacturing, have increased. The present invention is an excellent invention capable of sufficiently meeting the market needs for implementing cost reduction of graphene manufacturing because graphene can be generated, without using a metal catalyst in the generating step, in the quartz vessel that is used industrially and generally.

The embodiments of the present invention will be described below using examples. However, the present invention is not limited to the following examples if it does not depart from the scope of the invention.

### Example 1

7.418 g of calcium hydroxide and water (predetermined amount) were put in a vessel and mixed. Natural gas (CO₂ concentration is 10.00%) was put in the vessel for 5 min. The CO₂ concentration (vol %) represents the concentration of CO₂ in the natural gas. In addition to CO₂, the natural gas contains methane, ethane, nitrogen, and butane. After 5 min, putting the natural gas in the vessel was stopped. The vessel was left stand for 5 min, thereby obtaining a precipitate of calcium carbonate. The gas in the vessel was sampled and analyzed, and it was confirmed that the amount of CO₂ processed (consumed) from the natural gas was 99.99%. The precipitate of calcium carbonate was put in a large electric furnace at 840° C. and fired for 10 min. A mixture containing carbon dioxide and water separated from the calcium carbonate was recovered from the gas supply port in the upper portion of the large electric furnace. The mixture was passed through a heat exchanger (more specifically, a stainless steel tube whose periphery was covered with dry ice) to remove water, thereby recovering a gas containing carbon dioxide. The recovered gas containing carbon dioxide was confined for 5 min in a quartz tube that was set to a vacuum state in advance in the large electric furnace, and then heated at 1,500° C. for 20 min. 1.187 g of graphene were generated/deposited inside the quartz tube. The chemical bond state of the generated graphene was measured by X-ray photoelectron spectroscopy (XPS).

### Example 2

Only differences from Example 1 will be described. In Example 2, the amount of calcium hydroxide was 3.709 g, the CO₂ concentration in natural gas was 5.00%, the natural gas introduction time was 2.5 min, the heating time of the gas containing carbon dioxide was 10 min, and the graphene generation amount was 0.579 g. As for the rest, graphene was generated in accordance with the same manufacturing step as in Example 1, and a detailed description thereof will be omitted.

### (Graphene Analysis Method)

X-ray photoelectron spectroscopy (X-ray source: monochromatized AlKa rays) was used to analyze the chemical bond states of graphene obtained in Examples 1 and 2 and a comparative example (commercially available graphite).

Figure is a view showing XPS analysis results of graphene of Examples 1 and 2 and a comparative example (commercially available graphite).

In Example 1 (curved line 101) and Example 2 (broken line 102) shown in Figure, when binding energy (abscissa) was 284 to 285, the peak of the intensity (ordinate) of emitted photoelectrons was conspicuously confirmed, and the intensity of the emitted photoelectrons exceeded 5.0. On the other hand, in the comparative example (curved line 103), when binding energy was 283, the peak of the intensity of emitted photoelectrons was slightly conformed. However, if the binding energy was 283 or more, the intensity of emitted photoelectrons decreased.

According to the analysis result shown in Figure, it was found that the intensity of emitted photoelectrons in Examples 1 and 2 was higher by about 20 times than in the comparative example (commercially available graphite). Thus, it was confirmed that graphene was generated by removing water from the mixture and heating the recovered gas containing carbon dioxide in the quartz tube at 1,500° C.

As described above, the present invention has a remarkable effect of mass-producing graphene at a low cost as compared to the conventional techniques.

The invention is not limited to the foregoing embodiments, and various variations/changes are possible within the spirit of the invention.

What is claimed is:

1. A graphene manufacturing method comprising:
recovering a gas containing carbon dioxide by removing water from a mixture containing the water and the carbon dioxide; and
generating graphene by heating the recovered gas containing the carbon dioxide in a quartz vessel at a temperature of not more than 1,700° C.

2. The method according to claim 1, wherein the recovering includes removing the water by cooling the mixture.

3. The method according to claim 2, wherein a temperature to cool the mixture (at 1 atm) is −78° C. to 100° C.

4. The method according to claim 1, wherein the generating includes heating the recovered gas containing the carbon dioxide in the quartz vessel without using a catalyst.

5. The method according to claim 1, wherein time to heat the recovered gas containing the carbon dioxide in the quartz vessel is 5 min to 1 hr.

6. The method according to claim 1, wherein an atmosphere in the quartz vessel is one of an inert gas or a vacuum.

7. The method according to claim 1, wherein the mixture is obtained by firing a precipitate of calcium carbonate obtained by causing the carbon dioxide to react with calcium hydroxide.

8. The method according to claim 7, wherein a temperature to fire the precipitate of the calcium carbonate is 600° C. to 1,500° C.

9. The method according to claim 7, wherein time to fire the precipitate of the calcium carbonate is 1 min to 7 hrs.
